(19) United States
(12) Patent Application Publication
(10) Pub. No.: US 2022/0043392 A1
(43) Pub. Date: Feb. 10, 2022

(54) APPARATUS FOR PRODUCING A REPLICA HOLOGRAM, REPLICA HOLOGRAM AND ILLUMINATING DEVICE FOR A VEHICLE

(71) Applicant: HELLA GmbH & Co. KGaA, Lippstadt (DE)

(72) Inventors: Markus GIEHL, Jena (DE); Daniela KARTHAUS, Lippstadt (DE); Martin MUEGGE, Geseke (DE)

(73) Assignee: HELLA GmbH & Co. KGaA, Lippstadt (DE)

(21) Appl. No.: 17/509,929

(22) Filed: Oct. 25, 2021

Related U.S. Application Data
(63) Continuation of application No. PCT/EP2020/057765, filed on Mar. 20, 2020.

(30) Foreign Application Priority Data
Apr. 24, 2019 (DE) 10 2019 110 587.0

(51) Int. Cl. G03H 1/02; G03H 1/00; G03H 1/20

(52) U.S. Cl. CPC G03H 1/0276; G03H 1/0248; G03H 1/0005; G03H 1/20; G03H 2223/24; G03H 2001/0296; G03H 2222/12; G03H 2270/32; G03H 2227/06

(57) ABSTRACT

A device for manufacturing a replica hologram, comprising a holder for a light-sensitive recording material, into which the replica hologram is to be imprinted, a holder for a master hologram, as well as a lighting device for generating light for exposing the master hologram, the color of the light generated by the lighting device being variable, and the lighting device comprising optics for exposing the master hologram with the aid of the light generated by the lighting device, the device being designed in such a way that the light emanating from the master hologram impinges on the recording material to manufacture the replica hologram.

This nonprovisional application is a continuation of International Application No. PCT/EP2020/057765, which was filed on Mar. 20, 2020, and which claims priority to German Patent Application No. 10 2019 110 587.0, which was filed in Germany on Apr. 24, 2019, and which are both herein incorporated by reference.

### BACKGROUND OF THE INVENTION

### Field of the Invention

The present invention relates to a device for manufacturing a replica hologram, a replica hologram manufactured with the aid of a device of this type, as well as an illuminating device for a vehicle including a replica hologram of this type.

### Description of the Background Art

A device for manufacturing a hologram, a hologram and an illuminating device including a hologram are known from DE 10 2016 107 210 A1. In the method described therein, a hologram, which is made up of a plurality of sub-holograms, is imprinted into a light-sensitive recording material. An object beam and a reference beam are successively applied to the sections of the recording material corresponding to the individual sub-holograms. The object beam is modulated by a light modulator, using computer-generated hologram information. A laser light source, which generates green light, is used as the light source for the object beam and the reference beam. The hologram, or a replica hologram manufactured as a master hologram with the aid of the hologram, may be integrated into a headlight of a motor vehicle.

The technology of volume holograms with the ability to generate and represent three-dimensional images and contents behind, inside or in front of a hologram surface is a highly interesting function execution for signal functions. The possibility of transferring optical functions, such as those from lenses, apertures or reflectors, to holograms expands the applications for holograms to illuminating systems. The transfer of general, large-format holograms into the limited installation space of lamps and headlights, as well as the additional requirements of different hologram geometries, for example flat and curved surfaces, make it desirable to facilitate a processing and creation of holograms for as many situations as possible. Accordingly, a device for replicating or duplicating or mass-producing holograms should be variably designed in such a way that different holograms and reconstruction wavelengths may be easily created. On the one hand, for example, red reconstructing holograms must be generated for taillights, and on the other hand, blue or cyan-colored holograms must be used for headlight applications or yellow holograms for designing turn signals. Other colors may be additionally interesting for holographic interior applications.

Different holograms having different reconstruction colors or reconstruction wavelengths may be provided in a taillight, a headlight or an interior light application. Large quantities of volume holograms are mass-produced with the aid of a device for manufacturing a replica hologram. Present devices for manufacturing a replica hologram are not able to replicate master holograms that are optimized for different wavelengths and flexible substrate geometries. Different devices are therefore used for different application purposes which require different reconstruction wavelengths. This corresponds to a high investment volume on the one hand. On the other hand, multiple different devices have correspondingly great space requirements. It is furthermore not improbable that at least some of the devices are not even fully utilized because only a few holograms are required for a certain color. If a color deviating from the possible reconstruction colors is then desired, a new device must then be additionally procured.

### SUMMARY OF THE INVENTION

It is therefore an object of the present invention to provide a device of the type mentioned at the outset, which permits a greater variability in terms of exposure and replication using different colors. Furthermore, a replica hologram manufactured with the aid of a device of this type as well as an illuminating device for a vehicle including a replica hologram of this type are to be specified.

According to an exemplary embodiment, the device for manufacturing a replica hologram comprises a holder for a light-sensitive recording material, into which the replica hologram as it be imprinted; a holder for a master hologram; as well as a lighting device for generating light for exposing the master hologram, the color of the light generated by the lighting device being variable, and the lighting device comprising optics for exposing the master hologram with the aid of the light generated by the lighting device, the optics being designed in such a way that the light emanating from the master hologram impinges on the recording material to manufacture the replica hologram.

In particular, the hologram is designed as a volume hologram. Due to the possibility of changing the color of the light generated by the lighting device, multiple expensive devices for manufacturing different replica holograms are no longer needed. The adaptability and variability of the exposure of master holograms may thus lower the investment costs and minimize the space requirements for the replication. A manufacturing of holograms of different colors using one device may be achieved, in particular, by simply retrofitting components or variably controlling light sources.

It may be provided that the lighting device includes multiple light sources, from which light emanates during the operation of the illuminating device, the light of at least one of the light sources differing from the light of at least one other of the light sources with respect to its wavelength spectrum. For example, to change the color of the light generated by the lighting device, one of the light sources may be positioned and/or activated in such a way that the light of this light source exits the lighting device. A change of this type may thus be brought about using simple means.

It is possible that the lighting device comprises a positioner, which may position the light sources in such a way that the light of at least one selected light source exits the lighting device, the positioner including, in particular, at least one step motor. The lighting device preferably comprises a rotatable and/or displaceable receptacle for the multiple light sources, the light of a first light source exiting the lighting device in a first position of the receptacle, and the light of a second light source exiting the lighting device in a second position of the receptacle relative to the first position, achieved by rotating and/or displacing the receptacle. The color of the light exposing the master hologram may thus be changed by a simple rotation or displacement of the receptacle.

In may be provided that the lighting device comprises a mixer for mixing the light emanating from the individual light sources, which combine and output the light emanating from these light sources when operating multiple light sources, or which only output the light emanating from this light source when operating only one single one of the light sources. Not only light of one color may be output thereby, which corresponds to the color of the light of one of the light sources, but mixtures of these colors may also be implemented.

It is possible that the mixer the light emanating from the individual light sources comprise a fiber coupler, multiple optical fibers being provided, by means of which the light of the light sources reaches the fiber coupler in each case. A fiber coupler is a simple way to combine the light of multiple light sources.

Alternatively, it is possible that in the mixer the light emanating from the individual light sources comprise at least one dichroic mirror. The light emanating from the individual light sources may also be effectively combined or applied to a shared optical axis with the aid of one or multiple dichroic mirrors.

It may be provided that the optics for exposing the master hologram are designed in such a way that they may be adapted to the color of the light used for the replication of the master hologram, the optics comprising, in particular, at least one movable lens. This makes it possible to achieve the fact that the exposure of the master hologram is reliably carried out. For example, the adaptation may be automated, so that an adaptation of the optics is automatically carried out during the selection of a light color.

It is possible that the device comprises a transparent substrate, it being possible to apply the master hologram to one side of the substrate and the light-sensitive recording material to the other side of the substrate. For example, a glass plate of a defined thickness may be used as the substrate during the replication of the master hologram to maintain a suitable distance between the master hologram and the recording material for the replication, for example the master hologram being laminated onto the upper side of the glass plate, and the recording material being laminated to the underside thereof.

It may be provided that the holder for the recording material and the holder for the master hologram may be identical or be connected to each other, the holder, in particular, holding the substrate with the master hologram on the one side and the recording material on the other side. In particular, the holder is designed as a suitable receptacle for the substrate, including the laminated-on master hologram and the laminated recording material.

It is possible that the light-sensitive recording material is designed as a film, in particular the device comprising a receptacle for the film wound onto a roll. The device is therefore more suitable for mass production of large quantities of volume holograms.

It may be provided that the light sources are designed as laser light sources and/or as light-emitting diodes. For example, the light source may be designed as a scanning laser light source, with the aid of which a linear or a single-point intensity distribution over the master hologram may be scanned, or as a laser light source for generating a wide-area illumination of the master hologram. For example, with the aid of a laser light source which scans a linear intensity distribution over the master hologram or implements a wide-area illumination of the master hologram, the process of replication may be carried out relatively quickly.

The replica hologram can be manufactured with the aid of a device according to the invention, the replica hologram being provided, in particular, for application to a curved surface and/or for use with a light source having a predefined light color.

The illuminating device for a vehicle comprises a replica hologram according to the invention, the illuminating device comprising, in particular, a curved surface, on which the replica hologram is arranged.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a detail of an exemplary embodiment of a device according to the invention;

FIG. 2 shows a schematic top view of an exemplary embodiment of a device according to the invention;

FIG. 3 shows a schematic top view of an exemplary embodiment of a lighting device of a device according to the invention;

FIG. 4 shows a schematic top view of an exemplary embodiment of a lighting device of a device according to the invention;

FIG. 5 shows a schematic top view of a detail of an exemplary embodiment of a lighting device of a device according to the invention.

### DETAILED DESCRIPTION

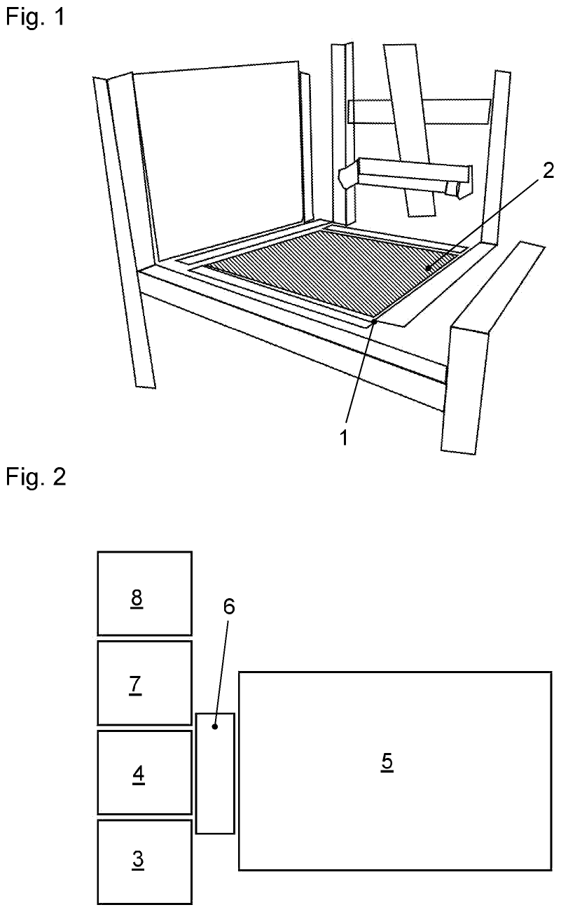

A device apparent from FIG. 1 and FIG. 2 comprises a receptacle or holder 1 for a master hologram 2 and a light-sensitive recording material, into which a replica hologram may be imprinted. The device further comprises a lighting device, including at least one light source and optics for exposing the master hologram with the light generated by the lighting device, the optics being designed in such a way that the light emanating from master hologram 2 impinges on the recording material to manufacture the replica hologram.

A glass plate used as a substrate and having a thickness defined for the exposure process or replication process is provided for holding master hologram 2 and the recording material, master hologram 2 being laminated onto a first side thereof, for example the upper side, and the recording material being laminated to the other side thereof, for example the underside.

Alternatively, it is also possible for master hologram 2 and recording material to rest against each other directly, the substrate situated therebetween then being able to be dispensed with.

FIG. 2 shows the schematic structure of a specific embodiment of a device according to the invention. The light-sensitive recording material is designed as a film and is stored as rolled goods in a mechanical receptacle 3. The light-sensitive recording material designed as a film is supplied to an exposure area 4, into which master hologram 2 is integrated. The lighting device comprises a light-generating part 5 and optics 6, which apply the light emanating from light-generating part 5 onto master hologram 2.

After the exposure, the light-sensitive recording material designed as a film is further transported to a bleaching box 7, in which the newly imprinted replica hologram is fixed by means of daylight and UV light. The hologram film is subsequently wound again onto a roll in a further station 8 or separated for the further manufacturing steps for integration into a lamp or headlight.

Light-generating part 5 of the lighting device comprises a plurality of light sources 9a, 9b, 9c, 9d, 9e, 9f. Light sources 9a, 9b, 9c, 9d, 9e, 9f are designed, in particular, as laser light sources. In particular, light sources 9a, 9b, 9c, 9d, 9e, 9f may be designed as scanning laser light sources, by means of which a linear or single-point intensity distribution over master hologram 2 may be scanned with the aid of optics 6, or which may be designed as laser light sources for generating a wide-area illumination of master hologram 2.

Alternatively, light sources 9a, 9b, 9c, 9d, 9e, 9f may also be designed as light-emitting diodes (LEDs).

In particular, light sources 9a, 9b, 9c, 9d, 9e, 9f may be designed in such a way that the light of one of each of light sources 9a, 9b, 9c, 9d, 9e, 9f differs from the light of other light sources 9a, 9b, 9c, 9d, 9e, 9f with respect to its wavelength spectrum. For example, a first light source 9a may generate red light, while a second light source 9b generates blue light and a third light source generates green light.

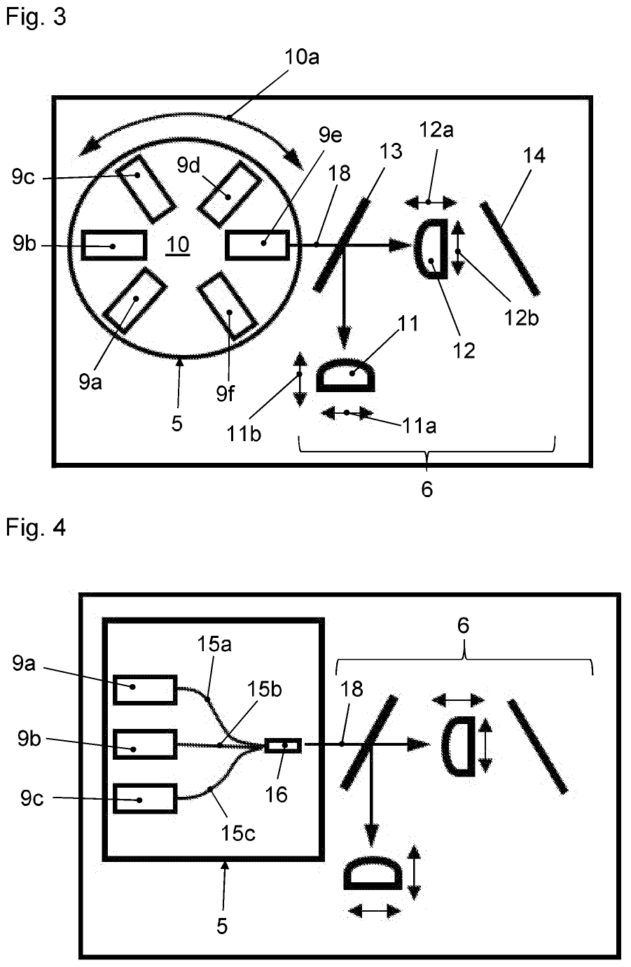

In the exemplary embodiment illustrated in FIG. 3, light-generating part 5 of the lighting device comprises a rotatable receptacle 10 designed as a rotating plate, on which light sources 9a, 9b, 9c, 9d, 9e, 9f are arranged in a circular manner around a center point. In FIG. 3, the rotatability is illustrated by arrow 10a. Light-generating part 5 further comprises at least one step motor used as a positioner, with the aid of which the receptacle may be rotated in such a way that light 18 of a selected light source 9e exits light-generating part 5. The reaching of the exact position of light source 9e may be monitored by a location or position control.

It is entirely possible to provide a linearly displaceable receptacle instead of a rotatable receptacle, on which light sources 9a, 9b, 9c, 9d, 9e, 9f are arranged side by side, it then being possible to select one of light sources 9a, 9b, 9c, 9d, 9e, 9f by linearly displacing the receptacle.

Two lenses 11, 12 and two mirrors 13, 14 of optics 6 are indicated schematically in FIG. 3, of which lenses 11, 12 are movable, for example, along arrows 11a, 11b; 12a, 12b. Mirrors 13, 14 may also be movable. It is thereby possible to adapt optics 6 to selected light source 9e, in particular to the color of light 18 of light source 9e used for replicating master hologram 2. A computer-controlled positioning may take place with the aid of exact positioner for optics 6, so that an existing, stored position and location arrangement of the optical components may be called up and set when changing colors.

In the specific embodiment illustrated in FIG. 4, light-generating part 5 of the lighting device comprises a plurality of light sources 9a, 9b, 9c instead of a rotating plate, whose light is conducted by optical fibers 15a, 15b, 15c and combined with the aid of a fiber coupler 16. Light sources 9a, 9b, 9c may be, for example, a first light source 9a emitting red light, a second light source 9b emitting green light, and a third light source 9c emitting blue light.

On the one hand, it is possible to activate only one of light sources 9a, 9b, 9c, so that light 18a, 18b, 18c is emitted only by this one light source. In this way, for example, red light or green light or blue light may then be output by light-generating part 5 of the lighting device.

On the other hand, two or all of light sources 9a, 9b, 9c may be activated in such a way that they emit light 18a, 18b, 18c, their light 18a, 18b, 18c being mixed by the fiber coupler. A desired color of the light 18 emanating from light-generating part 5 of the lighting device may be set by changing the light intensities of individual light sources 9a, 9b, 9c. In this case as well, a computer-controlled positioning may take place with the aid of exact positioner for optics 6, so that an existing, stored position and location arrangement of the optical components may be called up and set when changing colors.

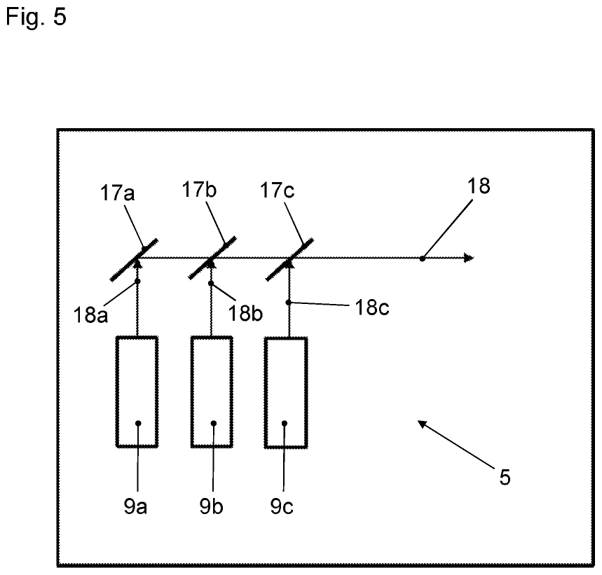

In the specific embodiment illustrated in FIG. 5, light-generating part 5 of the lighting device comprises a plurality of mirrors 17a, 17b, 17c instead of a fiber coupler 16, which are used to combine light 18a, 18b, 18c emanating from individual light sources 9a, 9b, 9c or to apply it to a shared optical axis. Middle mirror 17b in FIG. 5 and right-hand mirror 17c in FIG. 5 are designed as dichroic mirrors, which each reflect light 18b, 18c of assigned light source 9b, 9c and allow light 18a, 18b of the other light sources 9a, 9b to pass through with as little hindrance as possible.

In this case as well, on the one hand, it is possible to activate only one of light sources 9a, 9b, 9c in such a way that light 18a, 18b, 18c is emitted only by this one light source. On the other hand, two or all of light sources 9a, 9b, 9c may be activated in such a way that they emit light 18a, 18b, 18c, their light 18a, 18b, 18c being mixed by mirrors 17a, 17b, 17c.

In this specific embodiment as well, a computer-controlled positioning may also take place with the aid of exact positioner for optics 6, so that an existing, stored position and location arrangement of the optical components may be called up and set when changing colors.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for manufacturing a replica hologram, the device comprising:
a holder for a light-sensitive recording material, into which the replica hologram is to be imprinted;
a holder for a master hologram;
a lighting device to generate light for exposing the master hologram, a color of the light generated by the lighting device being variable; and
the lighting device comprising optics for exposing the master hologram with the aid of the light generated by the lighting device, the optics being designed in such a way that the light emanating from the master hologram impinges on the recording material to manufacture the replica hologram.

2. The device according to claim 1, wherein the lighting device comprises multiple light sources from which light emanates during the operation of the lighting device, the light of at least one of the light sources differing from the light of at least one of the other light sources with respect to its wavelength spectrum.

3. The device according to claim 2, wherein, to change the color of the light generated by the lighting device, one of the light sources is positioned and/or activated such that the light of this light source exits the lighting device.

4. The device according to claim 3, wherein the lighting device comprises a positioner, which positions the light sources in such a way that the light of at least one selected light source exits the lighting device, the positioner including at least one step motor.

5. The device according to claim 3, wherein the lighting device comprises a rotatable and/or displaceable receptacle for the multiple light sources, the light of a first light source exiting the lighting device in a first position of the receptacle, and the light of a second light source exiting the lighting device in a second position of the receptacle relative to the first position reached by rotating and/or displacing the receptacle.

6. The device according to claim 2, wherein the lighting device comprises mixer the light emanating from the individual light sources, which, when operating multiple light sources combine and output the light emanating from these light sources and, when only an individual one of the light sources is operated, output the light emanating from this light source.

7. The device according to claim 6, wherein the mixer the light emanating from the individual light sources comprise a fiber coupler, multiple optical fibers being provided, through each of which the light of the light sources reaches the fiber coupler.

8. The device according to claim 6, wherein the mixer the light emanating from the individual light sources comprise at least one dichroic mirror.

9. The device according to claim 1, wherein the optics for exposing the master hologram are designed in such a way that they may be adapted to the color of the light used for the replication of the master hologram, the optics comprising at least one movable lens.

10. The device according to claim 1, wherein the device comprises a transparent substrate, and adapted to apply the master hologram to one side of the substrate and the light-sensitive recording material to the other side of the substrate.

11. The device according to claim 1, wherein the holder for the recording material and the holder for the master hologram are substantially identical or are connected to each other, the holder holding the substrate, including the master hologram, on a first side and the recording material on a second side.

12. The device according to claim 1, wherein the light-sensitive recording material is designed as a film, in particular the device comprising a receptacle for the film wound onto a roll.

13. The device according to claim 2, wherein the light sources are designed as laser light sources and/or as light-emitting diodes.

14. A replica hologram manufactured with the aid of a device according to claim 1, the replica hologram being provided for application to a curved surface and/or for use with a light source having a predefined light color.

15. An illuminating device for a vehicle, comprising a replica hologram according to the claim 14, the illuminating device comprising a curved surface, on which the replica hologram is arranged.
